(19) United States
(12) Patent Application Publication
(10) Pub. No.: US 2026/0115637 A1
(43) Pub. Date: Apr. 30, 2026

(54) GAS TREATMENT APPARATUS FOR VENT

(71) Applicant: Building Healthcare Solutions, LLC, Las Vegas, NV (US)

(72) Inventors: Gerard Joseph Amlin, Las Vegas, NV (US); Bryan Keith Cooper, Sarasota, FL (US)

(21) Appl. No.: 19/429,315

(22) Filed: Dec. 22, 2025

Related U.S. Application Data
(63) Continuation of application No. PCT/US25/11782, filed on Jan. 16, 2025.
(60) Provisional application No. 63/621,838, filed on Jan. 17, 2024.

(51) Int. Cl. B01D 39/20; B01D 53/04

(52) U.S. Cl. CPC B01D 39/2062; B01D 53/0407; B01D 2201/0415; B01D 2201/4023; B01D 2253/102; B01D 2256/12; B01D 2257/304; B01D 2257/406; B01D 2257/504; B01D 2257/7025; B01D 2257/91; B01D 2259/804; B01D 2267/30; B01D 2267/60; B01D 2279/35

(57) ABSTRACT

An inline air treatment apparatus for a gas emitting system is provided. The air treatment apparatus includes a flow path having an inlet for coupling to the gas emitting system and an outlet for venting to an atmosphere. The air treatment apparatus includes a first activated charcoal filter and a second activated charcoal filter disposed in the flow path. The first activated charcoal filter and the second activated charcoal filter are configured to remove contaminants from the air passing therethrough. The air treatment apparatus includes a UV light source operable to emit UV light to air flowing in the flow path to inactivate microorganisms in the air. The UV light source is operable to emit UV light in the flow path between the first activated charcoal filter and the second activated charcoal filter.

### CROSS-REFERENCE TO RELATED APPLICATION(S)

This application is a continuation of International Application No. PCT/US2025/011782, filed Jan. 16, 2025, which designates the United States and was published in English by the International Bureau on Jul. 24, 2025 as WO 2025/155662, which claims the benefit of U.S. Provisional Application No. 63/621,838 filed Jan. 17, 2024, the entire contents of each of which are herein incorporated by reference.

### TECHNICAL FIELD

This disclosure relates generally to gas treatment and, more particularly, to gas treatment apparatuses for vents.

### BACKGROUND

Many buildings include a plumbing system with a vent stack or plumbing air vent on the roof. The plumbing air vent balances the pressure in the pipes of the plumbing system to aid sewage in draining from the building. The plumbing air vent also provides an outlet through which sewer gases can escape the plumbing system. These sewer gases often have a foul odor and may include chemicals and/or microorganisms that are harmful to humans. The sewer gases emanate from the plumbing air vent to the air surrounding the building. For example, when a low-pressure weather system is present, the sewer gases may flow from the sewer and/or plumbing system to the air about the building creating an unpleasant odor about the building. Such gases may be drawn into the building via a system of the building, such as a fresh air supply system that draws air from outside of the building, resulting in an unpleasant smell inside the building. When there is a high-pressure weather system at the building, the sewer gases may not vent through the plumbing air vent and instead build up in the sewer and pipes of the building. Sewer gas buildup may result in the sewer gases seeping into the building through the plumbing system, for example through the fixtures of the plumbing system. Other systems such as, for example, food waste recycling bins and garbage compactors, may similarly result in such noxious gases that results in an unpleasant smell in the vicinity.

### BRIEF DESCRIPTION OF DRAWINGS

FIG. 1A is a perspective view of an air treatment apparatus.

FIG. 1B is a schematic view of the air treatment apparatus of FIG. 1A.

FIG. 1C is a perspective view of a filter support of the air treatment apparatus of FIG. 1A.

FIG. 2 is a schematic view of a plumbing system of a building, the air treatment apparatus of FIG. 1A mounted to a vent pipe of the plumbing system.

FIG. 3A is a perspective view of an air treatment apparatus according to another embodiment having a fan.

FIG. 3B is a schematic view of the air treatment apparatus of FIG. 3A.

FIG. 4A is a perspective view of an air treatment apparatus according to another embodiment having a single piece housing.

FIG. 4B is an exploded view of the air treatment apparatus of FIG. 4A.

FIG. 5A is a perspective view of the single piece housing of the air treatment apparatus of FIG. 4A.

FIG. 5B is an enlarged view of a lower portion of the housing of FIG. 5A.

FIG. 6 is a schematic view of a food waste recycling bin system having an air treatment apparatus at a vent of a food waste recycling bin.

FIG. 7 is a perspective view of a garbage compactor system having an air treatment apparatus at a vent of a garbage compactor.

### DETAILED DESCRIPTION

A gas treatment apparatus such as an air treatment apparatus is provided to be connected to a gas emitting system to treat the gas (e.g., air carrying chemicals and/or microorganisms of the gas emitting system) before the gas is emitted to the surrounding environment. The gas treatment apparatus removes contaminants such as harmful and/or foul-smelling chemicals from the gas and inactivates microorganisms carried in the gas. The gas treatment apparatus is configured to be connected inline with the source from which gas emanates to clean the gas before the gas vents to the surrounding environment.

In one aspect, the air treatment apparatus includes a flow path having an inlet for coupling to the gas emitting system and an outlet for venting to an atmosphere. The air treatment apparatus includes a first activated charcoal filter and a second activated charcoal filter disposed in the flow path. The first activated charcoal filter and second activated charcoal filter are configured to remove contaminants from the air passing therethrough. The air treatment apparatus includes a UV light source operable to emit UV light to air flowing in the flow path to inactivate microorganisms in the air. The UV light source is positioned in the flow path between the first activated charcoal filter and the second activated charcoal filter.

In one aspect, the gas treatment apparatus is mountable to an end portion of a sewer vent pipe of a building to be inline with the gas emitting system (e.g., the sewer and/or building plumbing system). The gas treatment apparatus includes a mounting portion of a housing where the mounting portion is configured to engage a sewer vent pipe of a building to mount the gas treatment apparatus to the sewer vent pipe to clean the gas emitted from the sewer vent pipe. The gas treatment apparatus includes an outlet of the housing to vent gas to an atmosphere. The gas treatment apparatus includes a conduit portion of the housing where the conduit portion defines a flow path through which gas emitted from the sewer vent pipe flows to the outlet. The gas treatment apparatus includes one or more activated charcoal filters and a UV light source disposed in the flow path. The one or more activated charcoal filters are configured to remove contaminants from the gas passing therethrough. The UV light source is operable to emit UV light to gas flowing in the flow path to inactivate microorganisms in the gas.

In one aspect, a gas cleaner is provided that is mountable to a gas vent of a gas emitting system to clean the gas leaving the gas emitting system. The gas cleaner includes a housing supporting the gas cleaner as a single unit to be mounted to the gas vent of the gas emitting system and which is independent of the gas emitting system. Being independent of the gas emitting system, existing gas emitting systems are able to be retrofitted with the gas cleaner. The housing includes a central conduit portion, a mounting portion, and a first extension portion. The central conduit portion defines a linear flow path from an inlet to an outlet to vent the gas to ambient air. The mounting portion is at the inlet of the central conduit portion and configured to engage a gas vent of the gas emitting system to mount the housing to the gas vent. The housing is configured such that the linear flow path extends vertically when mounted to the gas vent. The first extension portion extends outward from the central conduit portion between the inlet and the outlet and includes an opening in fluid communication with the flow path. The gas cleaner includes one or more activated charcoal filters disposed in the flow path configured to remove contaminants from gas passing therethrough. At least one of the one or more activated charcoal filters is accessible via the first extension portion. A UV light source is disposed in the flow path and operable to emit UV light to gas flowing in the flow path to inactivate microorganisms in the gas.

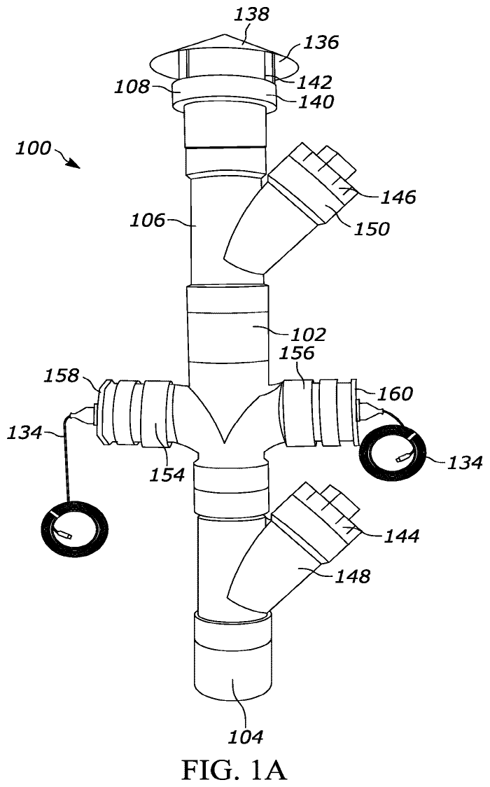

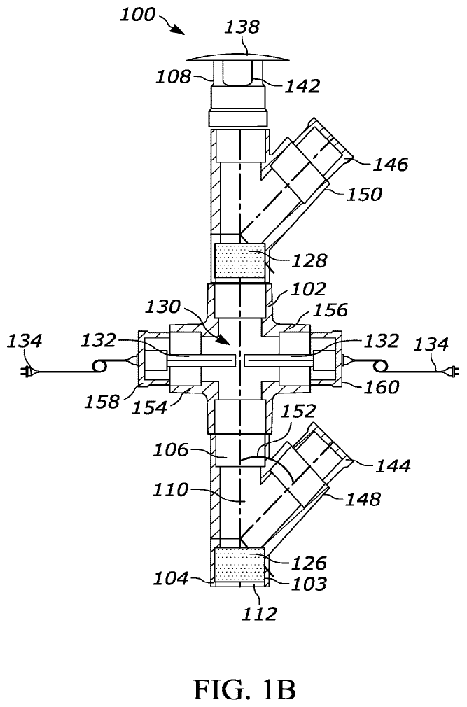

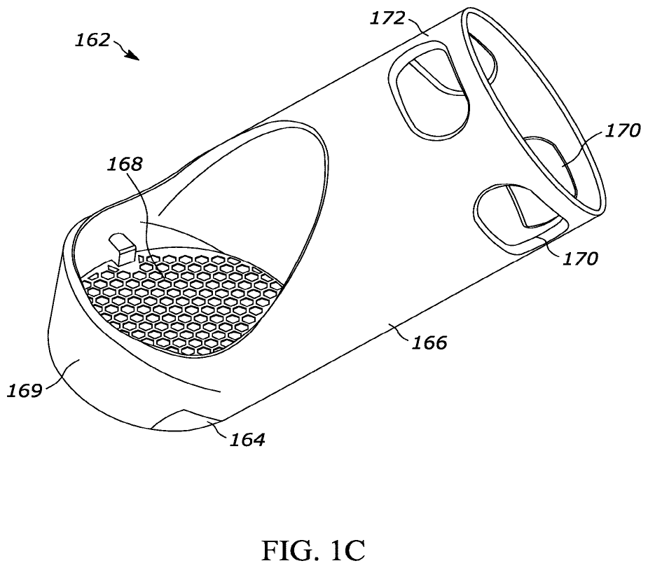

With respect to FIGS. 1A-1B, a gas treatment apparatus such as an air treatment apparatus 100 is provided. The air treatment apparatus 100 is to be mounted at a vent of a gas emitting system to treat the gas emitted from the gas emitting system to the surrounding environment (e.g., the atmosphere). The gas may be air mixed with and/or carrying other chemicals and microorganisms (e.g., bacteria, pathogens, viruses). The air treatment apparatus 100 cleans the air by removing moisture and contaminants from the air passing through the air treatment apparatus 100 to the environment, such as noxious or odorous chemicals (e.g., causing foul-smelling odors). The air treatment apparatus 100 also cleans the air by inactivating (e.g., killing) the microorganisms passing through the air treatment apparatus 100 to the environment. The gas emitting system may be a system where gas is generated (e.g., passively or actively by a process) or otherwise collects and builds up in the system, for example, a plumbing system, sewer system, a garbage compactor, grease trap vent system, portable toilet, waste collection bin (e.g., food waste), or a fume ventilation system.

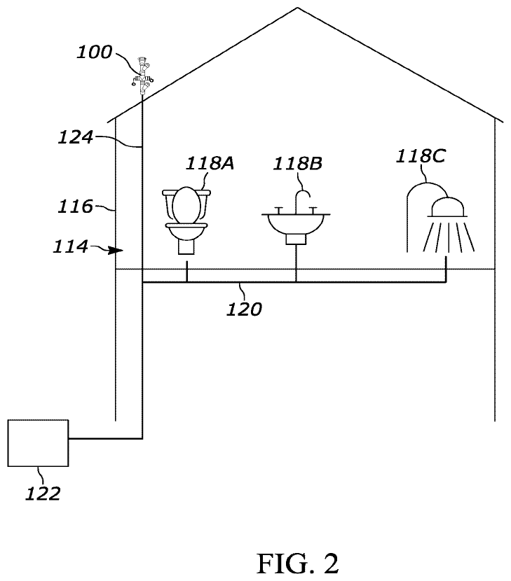

With respect to FIG. 2, a plumbing system 114 of a building 116 is shown. The plumbing system 114 may include a plurality of fixtures, for example, a toilet 118A, a sink 118B, and a shower 118C. The plumbing system 114 includes one or more pipes 120 that extend from the fixtures of the building 116 to a sewer system 122 to transfer liquid entering the pipes 120 from the fixtures (e.g., through a drain) to the sewer system 122. The plumbing system 114 also includes a vent pipe 124 which vents out of the roof of the building 116. The vent pipe 124 vents sewer gases from the plumbing system 114 and permits air to enter the plumbing system as liquid drains to the sewer system 122 (e.g., to prevent the formation of a vacuum in the pipes 120 which can slow or inhibit drainage). The air treatment apparatus 100 may be mounted to the vent pipe 124 to treat the sewer gases vented from the plumbing system 114.

Returning to FIGS. 1A-1B, the air treatment apparatus 100 includes a main body such as housing 102 including a mounting portion 104, a conduit portion 106, and an outlet 108. The housing 102 may be formed of a plastic or metal material, for example, polyvinyl chloride (PVC), Acrylonitrile Butadiene Styrene (ABS), ABS and fiberglass composite, and galvanized steel.

In some embodiments, the housing 102 is formed of multiple pieces assembled together. In some embodiments, the housing 102 has a unitary construction, being formed of a single piece.

The conduit portion 106 forms a flow path 110 from an inlet 103 at the mounting portion 104 to the outlet 108. The air treatment apparatus 100 may thus be an inline air treatment system positioned between the gas emitting system and the surrounding environment to treat all or a substantial portion of the air flowing from the gas emitting system to the environment. Mounting the air treatment apparatus 100 inline with the source ensures that all (or a substantial portion) of the gas emitted from the gas emitting system is treated as it emanates from the source. The mounting portion 104 is configured to be attached to a vent of the gas emitting system, such as the vent pipe 124. The mounting portion 104 may include an opening 112 having a dimension (e.g., a diameter) sized and shaped to receive an end of the vent pipe 124 therein to attach the housing 102 to the vent pipe 124.

For example, the mounting portion 104 may be sized to be slid over an end of the vent pipe 124 to quickly and easily install the air treatment apparatus 100 to an existing system. In some forms, the mounting portion 104 may be secured to the vent pipe 124 to inhibit the air treatment apparatus 100 from being unintentionally removed from the vent pipe 124. For example, the mounting portion 104 may be secured to the vent pipe 124 with a fastener (e.g., adhesive, screws). The mounting portion 104 may include one or more seals that extend between the mounting portion 104 and the vent pipe 124 when the mounting portion 104 is attached to the vent pipe 124 to inhibit gas from leaking therebetween and to ensure the gas flows along the conduit portion 106 and to the outlet 108 before being emitted to the environment to ensure the gas is treated before flowing to the environment.

The air treatment apparatus 100 includes a plurality of cleaning stages disposed in the flow path 110 from the inlet 103 to the outlet 108. In this embodiment, the air treatment apparatus 100 includes a first filter 126, a second filter 128, and a UV light source 130. The UV light source 130 may be between the first filter 126 and the second filter 128 such that the first filter 126 is upstream of the UV light source 130 and the second filter 128 is downstream of the UV light source 130 as gas flows along the flow path 110 from the inlet 103 to the outlet 108. The conduit portion 106 may be configured to extend vertically in use, for example, when mounted to a vent pipe 124. The first filter 126 may be at a first vertical position with the UV light source 130 at a second vertical position higher than the first vertical position. The second filter 128 may be at a third vertical position higher than the first vertical position and/or second vertical position.

The first filter 126 and second filter 128 may be an activated charcoal filter configured to remove moisture and/or contaminants from the gas flowing therethrough. For example, the activated charcoal filter may be configured to remove noxious chemicals (e.g., harmful or having an unpleasant odor) from the air, such as hydrogen sulfide, carbon dioxide, methane, and ammonia. The activated charcoal filters may remove the contaminants from the air as the air passes therethrough. For example, the activated charcoal filters may be configured to bind to toxins through adsorption, where chemicals desired to be removed from the air stick to the activated charcoal filter when the chemicals contact the filter. Including the first filter 126 in series with the second filter 128 aids to increase the amount of the noxious chemicals removed from the gas before exiting the air treatment apparatus 100. In other embodiments, the air treatment apparatus 100 may have more filter stages, for example, a third filter, or a fourth filter to increase the amount of noxious chemicals removed from the gas before exiting the air treatment apparatus.

The UV light source 130 is operable to emit UV light (e.g., UV-C light) into the flow path 110 to kill microorganisms carried in the air flowing in the flow path 110 and/or on the interior surfaces of the housing 102. The UV light source 130 may include a plurality of UV light sources such as low-pressure mercury bulbs or UV light emitting diodes (LEDs). The UV light source may emit light in the UV-C spectrum, for example, light having a wavelength in the range of about 200 nm to about 280 nm. UV-C light is effective at killing microorganisms when the microorganisms are exposed to a threshold average radiant exposure of UV-C light. Radiant exposure is irradiance of the UV light (the flux of radiant energy per unit area) multiplied by the time area is exposed to the UV light.

In one embodiment, the UV light source 130 includes two UV bulbs 132 that extend into the flow path 110 to provide a sufficient radiant exposure to the air flowing in the flow path 110 to inactivate, such as kill, the microorganisms (e.g., bacteria, pathogens, viruses, fungi, etc.) carried in the air. As one example, the UV bulbs 132 provide a radiant exposure to the air flowing in the flow path 110 to provide a 99.8% inactivation rate of microorganisms in the air. The UV bulbs 132 may be mounted on opposite sides of the housing 102 with the bulbs 132 extending toward one another. In some embodiments, the UV bulbs 132 are not mounted in the flow path 110 but are arranged to emit UV light into the flow path 110.

The UV light source 130 may be between the first filter 126 and second filter 128 in the flow path 110 to effectively remove noxious chemicals and inactivate microorganisms in the gas flowing along the flow path 110. Gas first flows through the first filter 126 along the flow path 110 to remove moisture and larger chemicals from the gas. The gas flows from the first filter 126 and through the UV light emitted from the UV light source 130 to inactivate any microorganisms carried in the gas that were not removed by the first filter 126. The gas then flows to the second filter 128 to remove any moisture or chemicals remaining in the gas that were not removed at the first filter 126. The UV light emitted by the UV light source may regenerate the activated carbon of the first and second filters 126, 128 and thus positioning the UV light source 130 between the first and second filters 126, 128 permits both the first and second filters 126, 128 to be regenerated by the UV light.

The UV light source 130 may include or be connected to a power source. In some forms, the UV light source 130 includes one or more power cords 134 to be plugged into an electrical outlet to provide electrical power to the UV bulbs 132. In some forms, the UV light source 130 includes a battery to provide electrical power to the UV bulbs 132 and an energy harvester that harvests energy from the environment to charge the battery. The energy harvester may include, for example, a solar panel and/or a wind turbine. Including a battery and an energy harvester is particularly useful in applications where the air treatment apparatus 100 is mounted outside of a building and exposed to the sun and wind, for example, when mounted to a vent pipe 124 on a roof of the building or portable toilet.

The interior of the housing 102 of the air treatment apparatus 100 or a portion thereof adjacent the UV light source 130 may be made of or be lined with a UV light reflective material, for example, galvanized steel, aluminum, and/or a UV light reflective polymer such as PTFE. Using a UV light reflective material about the UV light source 130 increases the overall UV irradiance in the housing 102 as the UV light is reflected back-and-forth through the flow path 110 several times, increasing the number of times a UV light wave may interact with microorganisms in the air. Where the housing 102 is formed of a plastic (e.g., PVC), the interior of the housing 102 or a portion thereof adjacent the UV light source may also be covered with a UV light reflective material to shield the housing 102 from damage (e.g., degradation) caused by the UV light.

Upon the gas passing through the cleaning stages of the first filter 126, UV light source 130, and second filter 128, the gas is able to flow out of the outlet 108 of the housing 102. The gas may be emitted outside of the building, for example, to the atmosphere. With the gas cleaned by the air treatment apparatus 100 before being emitted, the noxious chemicals are removed from the air and the microorganisms therein inactivated, making the air safer for humans to breathe. The air treatment apparatus 100 also removes foul-smelling odors that can be unpleasant to humans.

The air treatment apparatus 100 may include a rain cap 136 at the outlet 108 to inhibit rain and debris from entering the air treatment apparatus 100, while permitting air to enter and exit the air treatment apparatus 100. For example, the rain cap 136 may include a cap portion 138 having a rounded or angled top to inhibit rain and debris from falling into the air treatment apparatus and shaped to deflect rain and debris radially outward of the air treatment apparatus. The cap portion 138 may be supported above a mounting portion 140 having outlet openings 142 through which air is able to flow freely into and out of the air treatment apparatus 100.

The air treatment apparatus 100 includes removeable portions such as covers 144, 146 removably coupled to the housing 102 to access the first filter 126 and second filter 128. The cover 144 may be a threaded cap that can be unthreaded from the housing 102 to permit the first filter 126 to be removed from and/or inserted into the flow path 110 (e.g., to replace the first filter 126). Similarly, the cover 146 may be a threaded cap that can be unthreaded from the housing 102 to permit the second filter 128 to be removed from and/or inserted into the flow path 110 (e.g., to replace the second filter 128).

The housing 102 may include extension portions 148, 150 that extend radially outward from the conduit portion 106 through which the first filter 126 and second filter 128 may be accessed, for example, for replacement. The extension portions 148, 150 may extend at an oblique angle 152 (see FIG. 1B) to the flow path 110. The extension portions 148, 150 extend at a slight upward angle to make it easier to service the first filter 126 and/or second filter 128. For example, the angle of the extension portions 148, 150 may make it easier to replace and/or visually inspect the condition of the first filter 126 and/or second filter 128, with little to no spillage as discussed below. The covers 144, 146 may be coupled to the ends of the extension portions 148, 150 to permit access to openings of the extension portions 148, 150 to access the first and second filters 126, 128 in the flow path 110.

With respect to FIG. 1C, a filter support 162 is shown that may be removably inserted into one of the extension portions 148, 150 to support the first filter 126 or second filter 128 in the flow path 110. The air treatment apparatus 100 may include two filter supports 162 with one for each extension portion 148, 150. The filter support 162 includes a support portion 164 and a handle portion 166. The support portion 164 may include a mesh support surface 168 on which the first filter 126 or second filter 128 may be positioned. When inserted into the housing 102, the mesh support surface 168 may extend substantially perpendicularly to the flow path 110. The support portion 164 includes a sidewall 169 sized and shaped to contact an interior surface of the flow path 110 to limit insertion of the filter support 162 into the housing 102. The handle portion 166 extends from the support portion 164 (e.g., the mesh support surface 168) at an oblique angle that corresponds to the angle 152 between the flow path 110 and the extension portion 148, 150. The handle portion 166 may include one or more openings 170 at an end 172 opposite the support portion 164 enabling a user to grasp the filter support 162 to withdraw the filter support 162 from the housing 102 or insert the filter support 162 into the housing (e.g., to lower the filter support 162 down the extension portion 148, 150). The handle portion 166 may be cylindrical and may have a diameter corresponding generally to that of the extension portion 148, 150 to limit movement of the filter support 162 therein.

Due to the oblique angle of the extension portions 148, 150 and filter supports 162, the filter supports 162 may be drawn upward along the extension portion 148, 150 to partially remove the filter supports 162 to provide access to the filters 126, 128 without completely removing the filter supports 162. For example, the filter support 162 may be partially withdrawn to permit a user to view the filter 126, 128 supported thereon with a portion of the extension portion 148, 150 underneath the support portion 154 to catch any debris falling from the filter support 162. The filter support 162 may similarly be only partially withdrawn when replacing the filter 126, 128 such that any debris falling from the new or old filter 126, 128 during replacement is caught by the extension portion 148, 150. The old filter 126, 128 may be exposed to sunlight and/or UV light to regenerate the activated charcoal such that the filter 126, 128 may once again be used in the air treatment apparatus 100.

The housing 102 may include extension portions 154, 156 to which the UV bulbs 132 may be mounted. The air treatment apparatus 100 may include covers 158, 160 removably coupled to the extension portions 154, 156 to support the UV bulbs 132 in the flow path 110. The covers 158, 160 may include sockets to which the UV bulbs 132 may be threaded, with the power cords 134 extending through the covers 158, 160 to provide electrical power to the sockets to power the UV bulbs 132. The covers 158, 160 may be removed from the extension portions 154, 156 to access the UV bulbs 132, for example, to replace the UV bulbs 132.

In some embodiments, the air treatment apparatus 100 includes a control system operable to turn on the UV light source 130. The control system may turn on the UV light source 130 periodically for a period of time (e.g., 5 minutes every 15 minutes) to inactivate microorganisms. Turning the UV light source 130 off periodically may extend the length of time before the UV bulbs 132 need to be replaced compared to operating the UV bulbs 132 continuously. In some forms, the air treatment apparatus 100 includes a sensor that detects the flow of gas in the flow path 110. The control system may turn on the UV light source 130 upon detecting that gas is flowing through the flow path 110 toward the outlet 108. In some forms, the air treatment apparatus 100 includes one or more sensors to detect a pressure differential along the flow path 110 and the control system may operate the UV light source 130 upon detecting a pressure differential.

To install the air treatment apparatus 100, the air treatment apparatus 100 may be mounted to the gas emitting system as a single unit, independent of the gas emitting system. The mounting portion 104 of the housing 102 is attached to the vent pipe of the gas emitting system, for example, the plumbing system 114 of the building. Attaching the mounting portion 104 may include bringing the mounting portion 104 into engagement with the vent pipe 124, for example, sliding the mounting portion over an end portion of the vent pipe 124. The interior of the mounting portion 104 may have a size and/or shape such that an inner dimension of the mounting portion 104 corresponds to an outer dimension of the vent pipe 124 to snugly receive the vent pipe 124 therein (e.g., engagement by a friction fit). In some forms, a fastener such as a screw may be extended through the mounting portion 104 and into the vent pipe 124 to secure the housing 102 to the vent pipe 124. In some forms, an adhesive is disposed between the mounting portion 104 and the vent pipe 124 to secure the housing 102 to the vent pipe 124. The air treatment apparatus 100 may be oriented such that the conduit portion 106 and flow path 110 extend vertically.

The UV bulbs 132 may be installed in the bulb sockets of the covers 158, 160 and the covers 158, 160 threaded to the extension portions 154, 156 of the housing 102. The power cords 134 may be connected to a power source such as to an electrical outlet of the building. To replace the UV bulbs 132 (e.g., when they burn out), the covers 158, 160 may be removed, the UV bulb 132 unthreaded from the bulb socket and replaced with a new UV bulb 132. The covers 158, 160 may be reattached to the housing 102. The first filter 126 may be placed on the mesh support surface 168 of one filter support 162 and the second filter 128 placed on the mesh support surface 168 of the other filter support 162. The filter supports 162 may be extended into the extension portions 148, 150 to position the first filter 126 and second filter 128 in the flow path 110. The covers 144, 146 may be threaded onto the extension portions 148, 150 to close the openings of the extension portions 148, 150. To replace the first filter 126 and/or second filter 128, the respective covers 144, 146 may be removed from the extension portions 148, 150 of the housing and the filter supports 162 withdrawn from the housing 102 via the corresponding extension portion 148, 150. The old filter may be removed from the mesh support surface 168 of the filter support 162 and replaced with a new filter. The filter support 162 may be reinserted into the housing 102 via the corresponding extension portion 148, 150 to position the filter in the flow path and the covers 144, 146 attached to the housing 102.

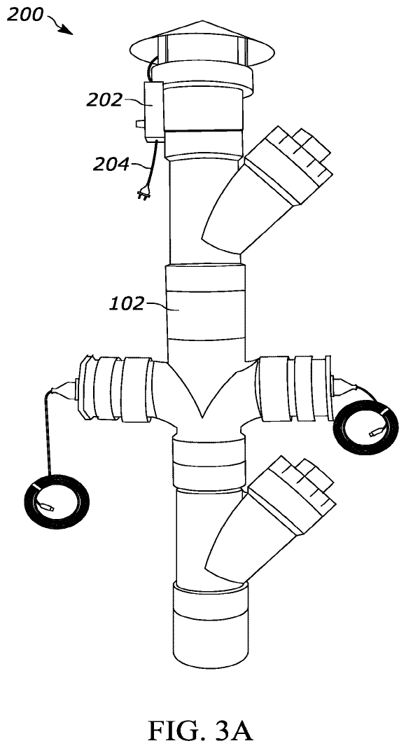

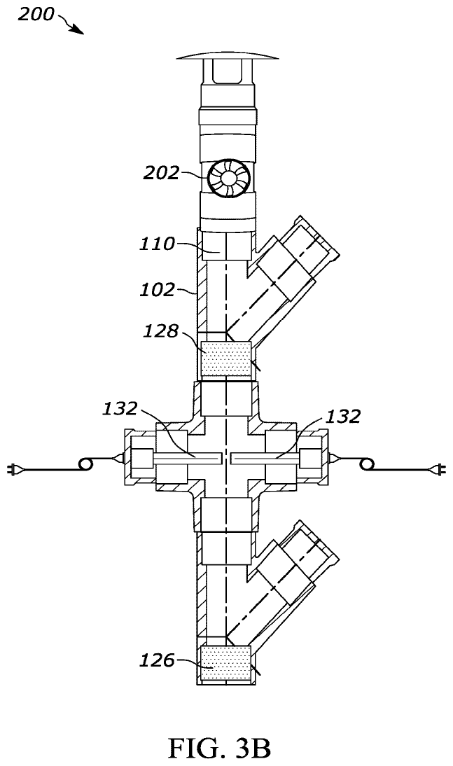

With respect to FIGS. 3A-3B, an air treatment apparatus 200 is provided according to another embodiment. The air treatment apparatus 200 is similar in many respects to the air treatment apparatus 100 such that the differences are primarily highlighted and similar reference numerals will be utilized for similar components. The air treatment apparatus 200 has an airflow generator such as a fan 202. The fan 202 is operable to cause air to flow along the flow path 110. The fan 202 may be operated to draw air through the first filter 126 and second filter 128 and about the UV bulbs 132. The fan 202 may be operated periodically, for example, to avoid the buildup of gases in the gas emitting system. For example, where the air treatment apparatus 100 is mounted to a vent pipe 124 of a plumbing system 114, the fan 202 may be operated continuously or periodically to exhaust gases from the plumbing system 114 to avoid untreated gas leaking from the plumbing system 114 into the building. The fan 202 may aid to draw the gas through the first filter 126 and second filter 128 to aid in overcoming the flow resistance caused by the first filter 126 and second filter 128.

The fan 202 may be a variable speed fan capable of being operated at various speeds depending on the application. For example, the speed of the fan 202 may be set based on the length and/or diameter of the vent pipe 124 to provide sufficient airflow to cause gas to vent from the plumbing system 114. For instance, the fan 202 may be set to operate at higher fan speeds where the air treatment apparatus 200 is connected to a longer and/or larger vent pipe 124 and, conversely, operated at a lower fan speed where the vent pipe 124 is shorter and/or smaller. In forms where the air treatment apparatus 200 includes one or more sensors to measure the ambient pressure and/or pressure in the vent pipe 124, the fan speed may be adjusted to overcome any pressure differential between the vent pipe 124 and ambient to cause gas to flow from the vent pipe 124 to the ambient. The fan 202 may include a power cord 204 connectable to an electrical outlet (e.g., of the building) to provide electrical power to the fan 202. In other embodiments, the fan 202 is powered by a battery, for instance, a battery used to power the UV light source 130.

In some embodiments, the air treatment apparatus 200 includes a control system operable to control the fan 202 and the UV light source 130. The control system may operate the fan 202 periodically (e.g., five minutes every 15 minutes) to exhaust gas from the gas emitting system. The control system may turn on the UV light source 130 when operating the fan 202 to inactivate the microorganisms carried in the gas exhausted from the air treatment apparatus 200. Operating the UV light source 130 when actively exhausting gas from the gas emitting system may ensure that the UV light source 130 is operated when gas is flowing in the flow path 110 and the UV light not continuously treating the same microorganisms when gas is not flowing. The UV light source 130 may be turned off when the fan 202 is turned off and it is not known whether gas is flowing in the flow path 110 to permit the UV bulbs 132 to be used over a longer period of time before needing replacement. The control system may turn on the fan 202 when there is a high pressure weather system to cause the gas to flow out of the vent pipe 124 despite the high pressure system to avoid gas buildup in the plumbing system 114.

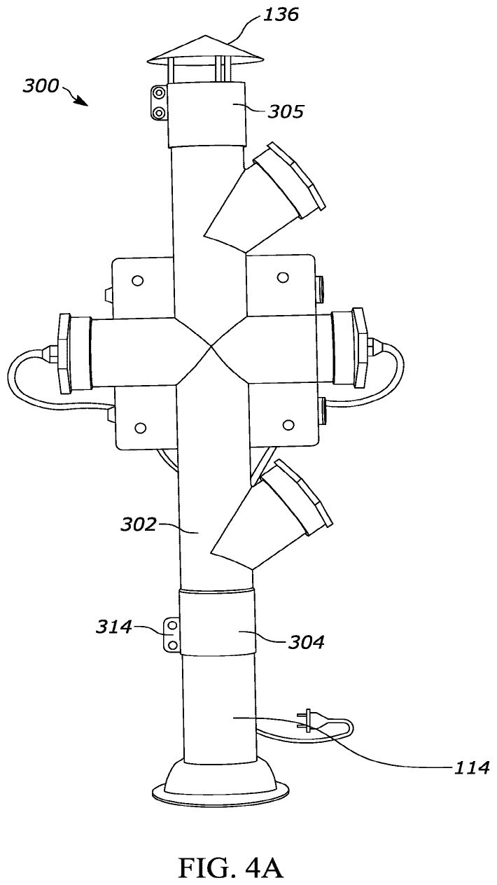

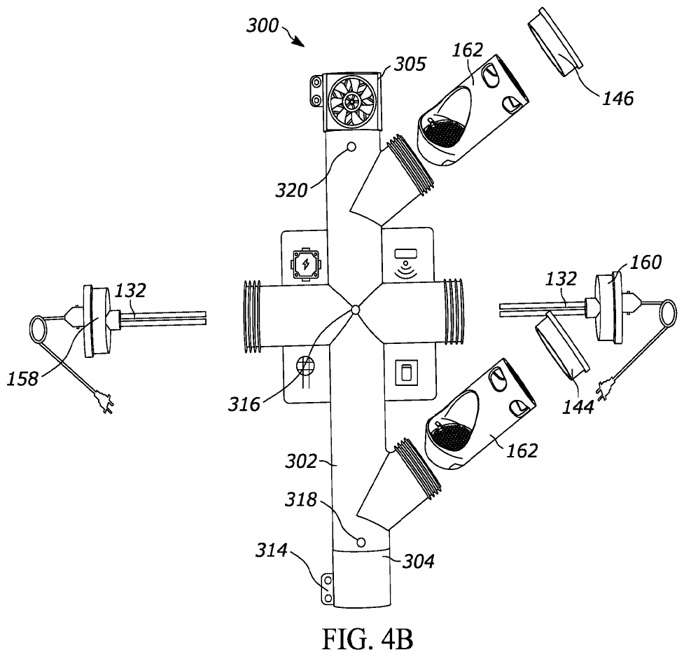

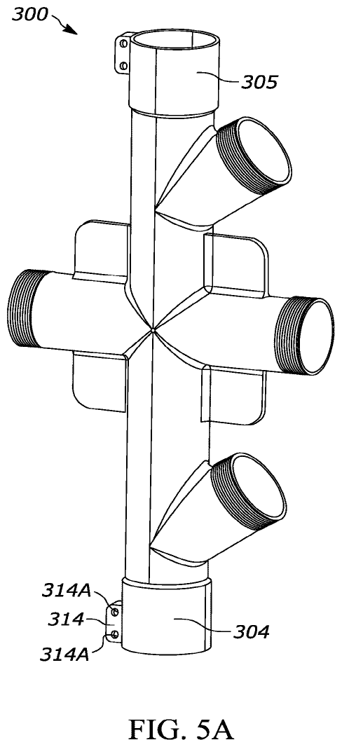

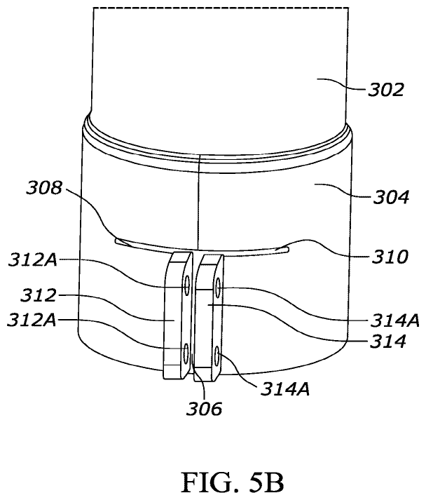

With respect to FIG. 4A-4B, an air treatment apparatus 300 is provided according to another embodiment. The air treatment apparatus 300 is similar to the embodiments discussed above such that the differences are primarily discussed and similar reference numerals will be utilized for similar components. The air treatment apparatus 300 has a single piece housing 302 (see FIG. 5A) to contain the first filter 126, second filter 128, and the UV light source 130. Forming the housing of a single piece reduces the points of entry for water intrusion and through which gas may leak from the air treatment apparatus 300 without being fully treated. Forming housing 302 as a single piece may permit the housing 302 to be formed of lighter composite materials (e.g., compared to using standard PVC piping). Forming the housing 302 as a single piece may also enable the overall length of the housing 302 to be shortened, as there may be less overlap to connect the separate pieces together.

Regarding FIGS. 5A-5B, the housing 302 has a lower end portion 304 configured to be secured to a pipe, such as vent pipe 124, to secure the air treatment apparatus 300 thereto. The lower end portion 304 is cylindrical and sized to slide over the vent pipe 124. The lower end portion 304 may be similar in diameter to the vent pipe 124 such that the vent pipe 124 fits snugly therein. The lower end portion 304 is configured to clamp about the vent pipe 124 to secure the air treatment apparatus 300 to the vent pipe 124. The lower end portion 304 includes a longitudinal slit 306 extending from the bottom end of the housing 302. Lateral slits 308, 310 extend laterally outward from the upper end of the longitudinal slit 306. The lower end portion 304 includes securement flanges 312, 314 extending radially outward from the cylindrical wall of the lower end portion 304 and along the longitudinal slit 306. The securement flanges 312, 314 each include one or more openings 312A, 314A through which a fastener (e.g., a nut and bolt) may be extended. The fastener may be tightened to draw the securement flanges 312, 314 together. The lateral slits 308, 310 permit the lower end portion 304 of the housing 302 to flex as the securement flanges 312, 314 are drawn together, permitting the lower end portion 304 to clamp to the vent pipe 124 to secure the air treatment apparatus 300 thereto. In other embodiments, the lower end portion 304 does not include the securement flanges and a worm gear clamp is placed about the lower end portion 304 to clamp to the vent pipe 124. The upper end portion 305 of the housing 302 may be configured similar to the lower end portion 304, for example, to secure the upper end portion to a rain cap 136.

Returning to FIGS. 4A-4B, the housing 302 may include an inspection port 316 through which a user may determine whether the UV light source 130 therein is on without having to open the housing 302. The inspection port 316 may include glass covering an opening in the housing 302 at the portion of the housing 302 where the UV light source 130 is positioned. The glass may be a uranium glass that turns green when exposed to UV light such that a user can quickly determine whether the UV light source 130 of the air treatment apparatus 300 is working properly.

The air treatment apparatus 300 may include one or more gas detection sensors 318, 320. The gas detection probes may extend through openings or ports in the housing 302. The air treatment apparatus 300 may include an upstream sensor 318 to detect the presence of chemicals and/or microorganisms in the flow path 110 upstream of the first filter 126, second filter 128, and UV light source 130. The air treatment apparatus 300 may include a downstream sensor 320 to detect the presence of chemicals and/or microorganisms in the flow path 110 downstream of the first filter 126, second filter 128, and UV light source 130. The data of the upstream sensor 318 and downstream sensor 320 may be compared to evaluate the effectiveness of the first filter 126, second filter 128, and UV light source 130 in removing contaminants and microorganisms from the gas flowing through the air treatment apparatus 300. The downstream sensor 320 may be used to determine the makeup/quality of the gas emitted to the environment, for example, the types and amounts of chemicals and/or microorganism remaining in the gas. The downstream sensor 320 may be used to determine when to replace the first filter 126, second filter 128, and/or UV bulbs 132, for example, when the sensor data indicates the air treatment apparatus 300 is less effective than the air treatment apparatus 300 was previously. The data of the upstream sensor 318 may be used to determine when to turn on the fan 202 and/or UV light source 130. For example, upon detecting an increased concentration of various chemicals indicating a lack of gas flow along the flow path, a control system may turn on the fan 202 to cause gas to flow through the air treatment apparatus 300. As another example, upon detecting the presence of and/or an increased concentration of microorganisms at the upstream sensor 318 (e.g., above a threshold level) the control system may turn on the UV light source to inactivate the microorganisms in the gas. The air treatment apparatus 300 may also include one or more pressure sensors to measure the pressure upstream and/or downstream of the first filter 126, second filter 128, and UV light source 130 to measure and control the air treatment apparatus 300 based on the ambient pressure and/or pressure in the vent pipe 124 as discussed above.

The air treatment apparatus 300 may include a control system 322 that operates the air treatment apparatus 300 based on sensor data and/or environmental conditions. The control system 322 may include a processor and memory. The memory may store programs and functions regarding how to control the UV light source 130 and/or fan 202 based on the sensor data, environment conditions, and/or user input. The processor may be operably coupled to the electrical components of the air treatment apparatus, such as the sensors, fan 202, and/or UV light source 130. The processor may receive the data from the sensors and control the fan 202 and/or UV light source 130 based at least in part on the sensor data. The air treatment apparatus 300 may include communication circuitry by which the processor is able to receive information from a remote computer (e.g., ambient conditions, weather conditions or forecasts, etc.) and/or send information such as reports of the sensor data and/or air treatment apparatus 300 operation (e.g., fan or light runtime information). The communication circuitry may be configured to communicate with a remote computer directly and/or indirectly via a network. For example, the communication circuitry may include a cellular modem to communicate with a remote computer over a cellular network. As another example, the communication circuitry may be configured to communicate locally, for example, via Bluetooth. The processor may control the fan 202 and/or UV light source 130 based at least in part on the environmental data received remotely from the remote computer.

The control system 322 may operate the fan 202 at a speed to ensure that gas is flowing out of the air treatment apparatus 300 from the vent pipe 124, for example, to vent gas from the plumbing system 114 even when a high-pressure weather system is present. The control system 322 may determine to operate the fan 202 based on sensor data indicating the ambient air pressure and/or based on weather data received from the remote computer. The control system 322 may operate the fan 202 and/or set a speed of the fan based on the data of the upstream gas detection sensor 318. For example, when the concentration of certain chemicals and/or microorganisms exceeds a threshold, the control system 322 may operate the fan 202 and/or increase the fan speed to treat the gas in the vent pipe 124 to keep the concentration below a threshold. The threshold concentration for each monitored chemical and/or microorganism may be set by an installer when programming the air treatment apparatus and/or be adjustable via the communication circuitry. In some forms, a user may remotely control the air treatment apparatus 300 via the communication circuitry, for example, via a software program such as a smartphone application. The user may be able to use the software program to turn the UV light source 130 on/off, adjust a power level of the UV light source 130, turn the fan 202 on/off, adjust the fan speed, adjust the parameters for operating the air treatment apparatus 300 responsive to the sensor data (e.g., threshold pressures, threshold chemical concentration levels, etc.).

The control system 322 may also store data relating to servicing of the air treatment apparatus 300. For example, a technician may provide input to the control system 322 (e.g., via the communication circuitry or a user interface (e.g., touchscreen display) of the air treatment apparatus) when the first filter 126, second filter 128, and/or UV bulbs 132 were replaced. The control system 322 may monitor the length of time since a component was last replaced and may output service reminders after a certain period of time since last serviced (e.g., when the filters and/or UV bulbs should be replaced). In some forms, the control system 322 determines the filters and/or UV bulbs are in need of replacement based on sensor data. For example, a light sensor may be used to determine when one or more of the UV bulbs 132 have burned out and need to be replaced. Similarly, a sensor, such as the downstream sensors 320, may be used to determine when the filters 126, 128 have lost their effectiveness.

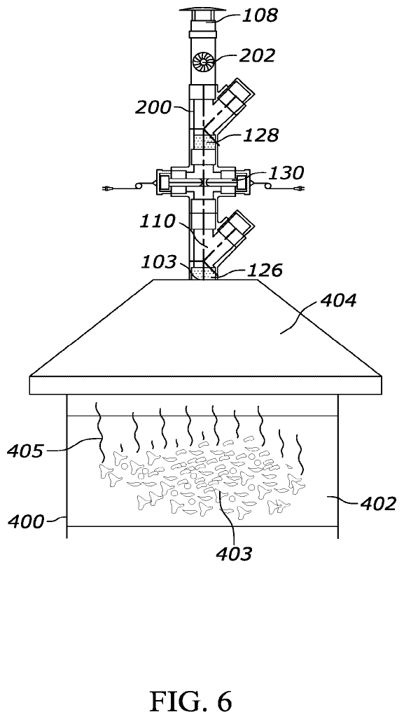

Regarding FIG. 6, the air treatment apparatus 200 is used to vent a food waste recycling bin 400. The air treatment apparatus 200 is provided by way of example and other embodiments of the air treatment apparatus disclosed herein could similarly be used with a food waste recycling bin. The food waste recycling bin 400 includes a receptacle 402 to receive food waste 403, for example, unused food waste from a restaurant. The food waste 403 may be stored in the food waste recycling bin 400 until the food waste is collected. Over time, the food waste in the receptacle begins to break down (e.g., from bacteria), emitting gas 405 that includes chemicals having an unpleasant smell such as hydrogen sulfide and ammonia. The inlet 103 of the air treatment apparatus 200 is connected to the receptacle 402 to place the air treatment apparatus 200 in fluid communication with an interior of the receptacle 402. The food waste recycling bin 400 may include a fume hood 404 above the receptacle 402 to collect the gases emitted from the food waste. The inlet 103 of the air treatment apparatus 200 may be connected to the fume hood 404. The gas emitted from the food waste may flow from the receptacle 402 and through the air treatment apparatus 200 to the surrounding environment. For example, the gas may flow to the inlet 103 and along the flow path 110 to the outlet 108 through the first filter 126 and second filter 128 and passed the UV light source 130. The air treatment apparatus 200 removes contaminants (e.g., chemicals such as hydrogen sulfide and ammonia) and inactivates any microorganisms carried in the gas flowing therethrough. The fan 202 of the air treatment apparatus 200 may be operated to cause gas to flow from the receptacle 402 and through the air treatment apparatus 200. Operating the fan 202 draws the gas from the receptacle 402, inhibiting the gas from building up in the receptacle untreated. The fan 202 causes the gas to be treated and emitted to the surrounding environment. And, because the gas is treated by the air treatment apparatus 200 before being emitted to the environment, the gas is clean having noxious and/or odorous chemicals removed therefrom and microorganisms inactivated. Using the air treatment apparatus 200 to vent the food waste recycling bin 400 thus results in a food waste recycling bin 400 that is not harmful or foul-smelling.

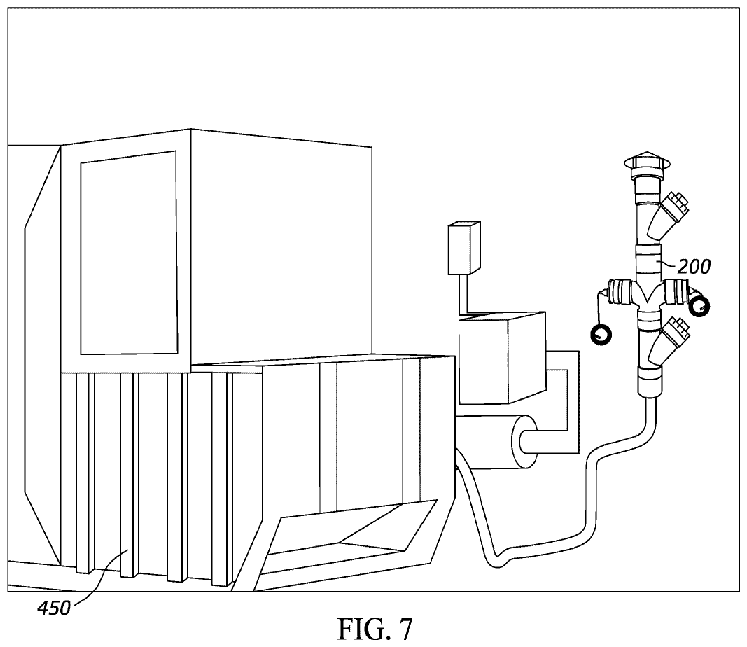

Regarding FIG. 7, the air treatment apparatus 200 is used to vent a garbage compactor 450. The air treatment apparatus 200 is provided by way of example and other embodiments of the air treatment apparatus disclosed herein could similarly be used with a garbage compactor. The inlet 103 of the air treatment apparatus 200 is connected to a port or opening of the garbage compactor 450. For example, one end of a hose connects to the opening of the garbage compactor 450 and the other end of the hose connects to the inlet of the air treatment apparatus 200. The air treatment apparatus 200 may replace an ozone generator of the garbage compactor 450 and be connected to the garbage compactor 450 via the opening used for the ozone generator. Gases emitted from the garbage in the garbage compactor may vent from the garbage compactor to the surrounding environment via the air treatment apparatus 200. The air treatment apparatus 200 cleans the gases flowing therethrough as discussed above, removing noxious chemicals and inactivating microorganisms carried in the gas. The fan 202 of the air treatment apparatus 200 may be operated to cause gas to flow therethrough to be cleaned and vented to the atmosphere, for example, to avoid gas building up in the garbage compactor 450.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

Uses of singular terms such as “a,” “an,” are intended to cover both the singular and the plural, unless otherwise indicated herein or clearly contradicted by context. For example, “a fan assembly” is intended to cover one or more fan assemblies. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

1. An inline air treatment apparatus for a gas emitting system, the air treatment apparatus comprising:
a flow path having an inlet for coupling to the gas emitting system and an outlet for venting to an atmosphere;
a first activated charcoal filter and a second activated charcoal filter disposed in the flow path, the first activated charcoal filter and second activated charcoal filter configured to remove contaminants from the air passing therethrough; and
a UV light source operable to emit UV light to the air flowing in the flow path to inactivate microorganisms in the air, the UV light source to emit the UV light to the air flowing between the first activated charcoal filter and the second activated charcoal filter.

2. The air treatment apparatus of claim 1 further comprising a housing defining the flow path, the first activated charcoal filter and the second activated charcoal filter disposed in the flow path of the housing.

3. The air treatment apparatus of claim 2 wherein the housing includes a mounting portion sized to receive an outlet portion of an air vent to mount the air treatment apparatus to the air vent as a single unit.

4. The air treatment apparatus of claim 2 wherein the housing includes one or more removable portions to provide access to the first activated charcoal filter and the second activated charcoal filter.

5. The air treatment apparatus of claim 2 further comprising a first removable filter support insertable into the housing to support the first activated charcoal filter in the flow path and a second removable filter support insertable into the housing to support the second activated charcoal filter in the flow path.

6. The air treatment apparatus of claim 5 wherein the housing includes a central conduit portion defining the flow path and an extension portion extending outward of the central conduit portion, the first removeable filter support insertable into the central conduit portion through the extension portion with the extension portion supporting a portion of the removable filter support.

7. The air treatment apparatus of claim 1 wherein the first activated charcoal filter and second activated charcoal filter are configured to remove moisture and/or contaminants from air passing therethrough, the contaminants including one or more of hydrogen sulfide, carbon dioxide, methane, and ammonia.

8. The air treatment apparatus of claim 1 further comprising a fan operable to move air relative to the UV light source and through the first activated charcoal filter and the second activated charcoal filter.

9. The air treatment apparatus of claim 1 wherein the gas emitting system includes at least one of a plumbing system, a garbage compactor, portable toilet, waste collection bin, and a fume ventilation system.

10. The air treatment apparatus of claim 1 further comprising a battery to power the UV light source; and
an energy harvester operable to charge the battery.

11. The air treatment apparatus of claim 10 wherein the energy harvester includes a solar panel.

12. The air treatment apparatus of claim 1 wherein the first activated charcoal filter, the second activated charcoal filter, and the UV light source are mounted in the air vent.

13. An inline gas treatment apparatus mountable to a sewer vent pipe of a building, the inline gas treatment apparatus including:
a mounting portion of a housing, the mounting portion configured to engage the sewer vent pipe of the building to mount the gas treatment apparatus to the sewer vent pipe to clean the gas emitted from the sewer vent pipe;
an outlet of the housing to vent gas to an atmosphere;
a conduit portion of the housing, the conduit portion defining a flow path through which gas emitted from the sewer vent pipe flows to the outlet;
one or more activated charcoal filters disposed in the flow path, the one or more activated charcoal filters configured to remove contaminants from the gas passing therethrough; and
a UV light source operable to emit UV light to gas flowing in the flow path to inactivate microorganisms in the gas.

14. The inline gas treatment apparatus of claim 13 wherein the one or more activated charcoal filters include a first filter and a second filter downstream of the first filter.

15. The inline gas treatment apparatus of claim 14 wherein the UV light source is operable to emit UV light in the flow path downstream of the first filter and upstream of the second filter.

16. The inline gas treatment apparatus of claim 13 wherein the housing includes one or more removable covers, the one or more covers being removable to provide access to the one or more activated charcoal filters.

17. The inline gas treatment apparatus of claim 16 wherein the housing includes one or more extension portions extending outward from the conduit portion of the housing, the one or more removable covers closing ends of the one or more extension portions.

18. The inline gas treatment apparatus of claim 13 further comprising an airflow generator operable to move gas through the flow path relative to the UV light source and the one or more activated charcoal filters.

19. The inline gas treatment apparatus of claim 13 wherein the mounting portion includes an opening sized to receive at least a portion of the sewer vent pipe therein.

20. The inline gas treatment apparatus of claim 13 wherein the mounting portion includes a clamp to secure the housing to the sewer vent pipe.

21. A gas cleaner mountable to a gas vent of a gas emitting system to clean the gas leaving the gas emitting system, the gas cleaner comprising:
a housing supporting the gas cleaner as a single unit to be mounted to the gas vent of the gas emitting system and independent of the gas emitting system, the housing comprising:
a central conduit portion defining a substantially linear flow path from an inlet to an outlet to vent the gas to ambient air;
a mounting portion at the inlet of the central conduit portion configured to engage a gas vent of the gas emitting system to mount the housing to the gas vent, the housing being configured such that the substantially linear flow path extends vertically when mounted to the gas vent;
a first extension portion extending outward from the central conduit portion between the inlet and the outlet, the first extension portion including an opening in fluid communication with the flow path;
one or more activated charcoal filters disposed in the flow path configured to remove contaminants from gas passing therethrough, at least one of the one or more activated charcoal filters accessible via the first extension portion; and
a UV light source operable to emit UV light to gas flowing in the flow path to inactivate microorganisms in the gas.

22. The gas cleaner of claim 21 wherein the one or more activated charcoal filters includes the first activated charcoal filter and a second activated charcoal filter, wherein the first activated charcoal filter has a first vertical position in the flow path, the UV light source emits UV light at a second vertical position of the flow path above the first vertical position, and the second activated charcoal filter has a third vertical position in the flow path above the second vertical position.

23. The gas cleaner of claim 21 wherein the first extension portion extends at an oblique angle relative to the linear flow path.

24. The gas cleaner of claim 23 further comprising a first filter support removably insertable into the opening of the first extension portion, the first filter support configured to support at least one of the one or more activated charcoal filters in the flow path of the central conduit portion.

25. The gas cleaner of claim 24 wherein the first filter support includes a filter support portion and a handle portion, the filter support portion extending at an oblique angle to the handle portion to permit the filter support portion to extend perpendicularly to the linear flow path when the handle portion is aligned with the first extension portion.
